(19) United States
(12) Patent Application Publication
(10) Pub. No.: US 2013/0204716 A1
(43) Pub. Date: Aug. 8, 2013

(54) SYSTEM AND METHOD FOR A UNITED CLOUD-BASED PRODUCT CATALOG

(71) Applicant: Salesforce.com, inc., San Francisco, CA (US)

(72) Inventor: Muhammad Rehman, San Jose, CA (US)

(73) Assignee: SALESFORCE.COM, INC., San Francisco, CA (US)

(21) Appl. No.: 13/631,303

(22) Filed: Sep. 28, 2012

Related U.S. Application Data
(60) Provisional application No. 61/594,495, filed on Feb. 3, 2012.

(51) Int. Cl. G06Q 30/00; G06Q 30/02

(52) U.S. Cl. 705/14.73; 705/27.2

(57) ABSTRACT

Methods and systems are provided for creating and managing a product catalog including expanded product metadata in a multitenant computing environment. The method includes creating a new store and mapping it to a cloud service provider. A catalog is then created and mapped to the store. Catalog categories are then created and mapped to the catalog. A product is then created and mapped to the categories. A product family is then created, followed by the creation of a product bundle. The product bundle is presented to consumers in a web based interactive shopping experience hosted by the cloud based service provider.

### CROSS-REFERENCE TO RELATED APPLICATION

This application claims the benefit of U.S. provisional patent application Ser. No. 61/594,495, filed Feb. 3, 2012, the entire content of which is incorporated by reference herein.

### TECHNICAL FIELD

Embodiments of the subject matter described herein relate generally to computer systems and applications for providing a product catalog in a multi-tenant environment and, more particularly, to an expanded data model employing auxiliary product catalog metadata.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

Robust systems and applications for managing sales and service organizations have been developed for use in the multi-tenant environment. For example, enterprise customers may establish individual partitioned accounts with a sales cloud provider to license customer relationship management (CRM) applications. Similarly, enterprise customers of a service cloud provider may license customer service management applications and thereby leverage the efficiencies of the multi-tenant environment without compromising the security and confidentiality of their customer information.

Due to the disparate nature of sales/service applications (such as CRM applications) vis-à-vis product applications (such as online catalogs), robust online product catalog applications have not been deployed in currently known multi-tenant computing environments. Indeed, presently known online catalogs are limited to a stock-keeping unit (SKU) based product definition scheme. Systems and methods are thus needed for expanding current product catalog data models beyond the SKU-centric approach to include metadata objects supporting marketing campaigns, product bundling, partnering, customer interaction, localization, and the like.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures, and:

FIG. 1 is a schematic block diagram of a multi-tenant computing environment in accordance with an embodiment;

FIG. 2 is a schematic block diagram of a multi-tenant computing cloud system configured to manage product catalogs for a plurality of enterprise customers in accordance with an embodiment;

FIG. 3 is a schematic block diagram of an expanded data model for grouping disparate product offerings into distinct classes in accordance with an embodiment;

FIG. 4 is a flow chart illustrating a method for creating a product catalog in accordance with an embodiment;

FIG. 5 is a flow chart illustrating a method for editing and deleting product catalog fields in accordance with an embodiment;

FIG. 6 is a flow chart illustrating a method 600 for providing localization support for a product catalog in accordance with an embodiment;

FIG. 7 is a flow chart illustrating a method 700 for navigating a product catalog (shopping) in accordance with an embodiment;

FIG. 8 is a flow chart illustrating a method 800 for migrating an existing product catalog in accordance with an embodiment; and

FIG. 9 is a schematic block diagram illustrating a conceptual layout of a partnering arrangement involving two enterprise customers sharing product catalog information using a commerce cloud based catalog application in accordance with an embodiment.

### DETAILED DESCRIPTION

Embodiments of the subject matter described herein generally relate to a system and method for creating and managing a product catalog including expanded product metadata in a multitenant computing environment. The method includes creating a new store and mapping it to a cloud service provider. A catalog is then created and mapped to the store. Catalog categories are then created and mapped to the catalog. A product is then created and mapped to the categories. A product family is then created, followed by the creation of a product bundle. The product bundle is presented to consumers in a web based interactive shopping experience hosted by the cloud based service provider.

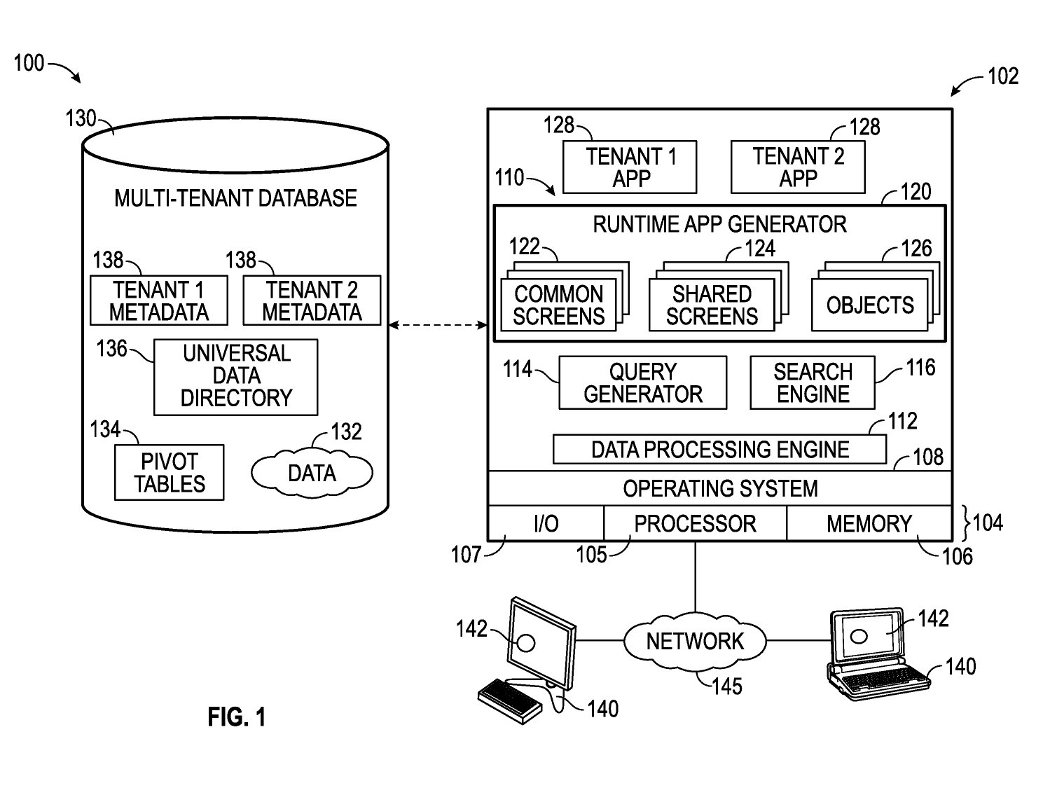

Turning now to FIG. 1, an exemplary multi-tenant system 100 includes a server 102 that dynamically creates and supports virtual applications 128 based upon data 132 from a database 130 that may be shared between multiple tenants, referred to herein as a multi-tenant database. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 130. In this regard, each tenant includes one or more users associated with, assigned to, or otherwise belonging to that respective tenant. Stated another way, each respective user within the multi-tenant system 100 is associated with, assigned to, or otherwise belongs to a particular one of the plurality of tenants supported by the multi-tenant system 100. Tenants may represent companies, corporate departments, business or legal organizations, and/or any other entities that maintain data for particular sets of users (such as their respective customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other tenants.

The multi-tenant database 130 may be a repository or other data storage system capable of storing and managing the data 132 associated with any number of tenants. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128, as described in greater detail below. The multi-tenant database 130 may alternatively be referred to herein as an on-demand database, in that the multi-tenant database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate.

As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

In accordance with one embodiment, application 128 may be an online product catalog application which may be licensed by an enterprise customer from the operator of the multi-tenant product cloud (also referred to as a commerce cloud). In an embodiment, the product catalog application may be configured to implement and/or facilitate the following functionality: i) a navigational architecture for defining a catalog system and for allowing an administrator to populate the catalog system with product SKUs and extended objects; ii) a system for allowing a consumer to navigate the catalog and view and purchase products; and iii) a platform for allowing an administrator to manipulate objects and strings, construct localization, and configure web pages for presenting the product catalog.

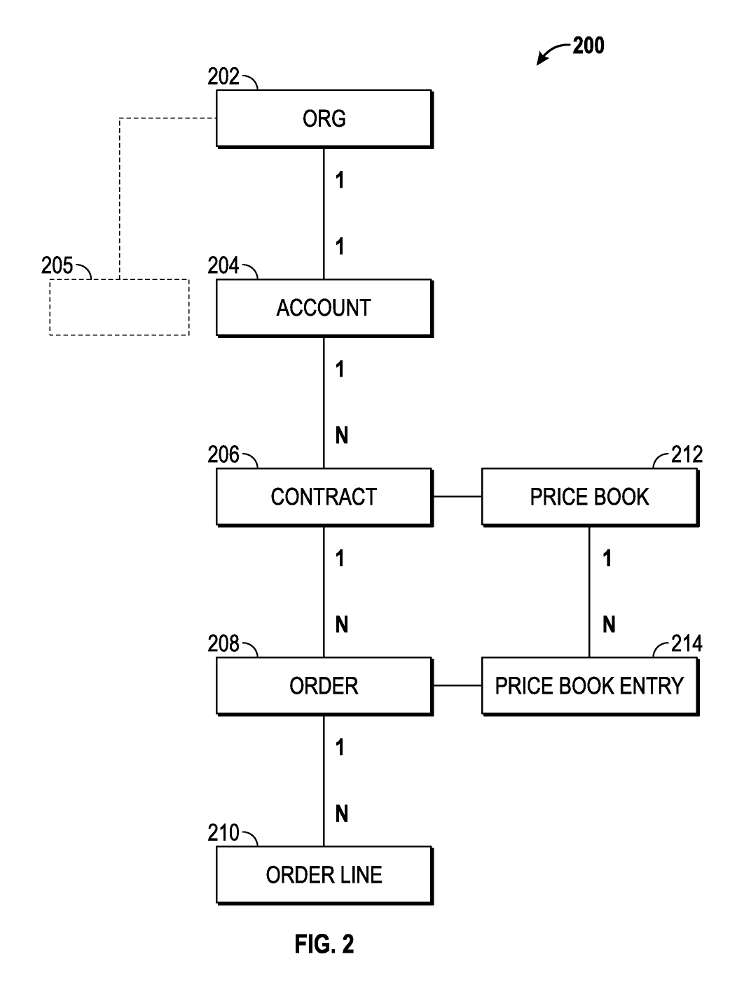

Referring now to FIG. 2, a system 200 for establishing and configuring an account relationship between a multitenant service provider and an enterprise customer is shown. In this context, the account relationship relates to a contract (or other business arrangement) between the cloud administrator (the multitenant service provider) and each of a plurality of customers to license or otherwise obtain access to a cloud-based product catalog application maintained by the cloud administrator (service provider).

More particularly, system 200 is maintained by the cloud administrator on the commerce cloud. Object 202 represents an enterprise customer desirous of obtaining a license to use the product catalog application offered by and maintained by the commerce cloud administrator. Objects 204 and 205 represents the enterprise customer in a particular country; for example, object 204 may represent XYZ Company in the U.S., object 205 may represent XYX Canada, and so on.

Object 206 represents the agreement, contract, or business arrangement for a licensed application such as a sales, CRM, service application, or the like. In the illustrated embodiment, object 206 represents a contract for an online product catalog system. Object 212 represents the price of object 206, for example, the annual license fee for the catalog. Object 208 represents one or more separately licensable sub-components (line items) of object 206. For example, if object 206 is a catalog system, object 208 may represent a consumer navigation (shopping) component or a product bundling component of the catalog system.

Object 210 represents one of various pricing sub-categories of object 208. For example, object 210 may be a catalog which embodies pricing for the sale of products to one of: i) governmental entities; ii) educational institutions; and iii) consumers. Object 212 represents the annual price, for example, the annual license fee, of the asset defined in object 206. Object 214 represents the price book entry for which for which the cost of object 212 is allocated, expressed in terms of a monthly, quarterly, or other accounting period. For example, if the annual license fee set forth in object 212 is $1,200 per year, the monthly allocation (price book entry) of that license fee may be defined in object 214 as $100 per month.

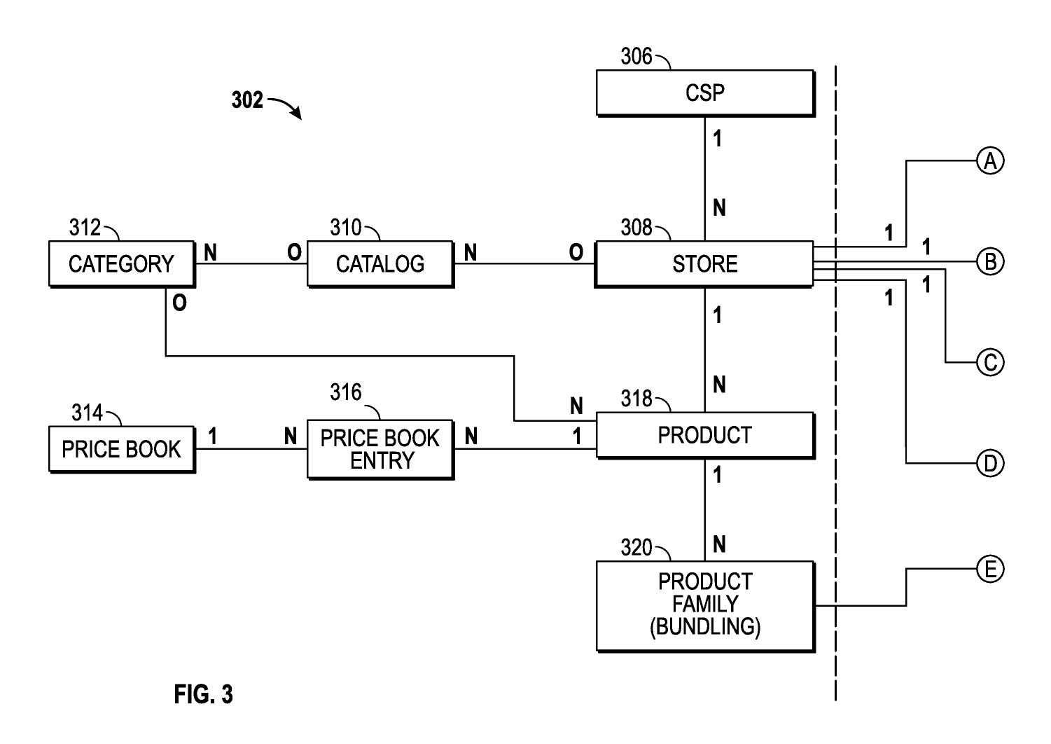

Referring now to FIG. 3, an expanded data model (system) 300 for efficiently grouping disparate product offerings into distinct classes, or product clouds, is disclosed. System 300 may be conceptually divided into a first module 302 (left side of FIG. 3) for defining and populating a product catalog system by an enterprise customer, and a second module 304 (right side of FIG. 3) for configuring an online shopping experience for a consumer of the foregoing enterprise customer.

More particularly and with continued reference to FIG. 3, first module 302 includes an object 306 which represents the commerce cloud service provider, i.e., the operator of the multitenant computing environment. Object 308 represents one of a possible plurality of stores within a particular enterprise customer's family of stores. For example, object 308 may define the XYZ Computer Company's U.S. online store, XYZ Computer Company's Canadian online store, XYZ's online store for consumers in Japan, and so on. Object 308 may further define a particular pricing sub-category for the store, such as a military, government, or consumer product pricing scheme.

Object 310 represents one of any number of products available from the store defined in object 308. For example, object 310 may represent laptop computers, desktop computers, printers, or any other product category. Object 312 represents one or more of a possible plurality of product sub-categories, such as product models. For example, if object 308 represents laptop computers, object 210 may represent an “Inspiron”™ laptop computer product line, a “Latitude”™ laptop computer product line, and so on.

Object 318 represents a unique product identifier for each product (or service) in the catalog, such as a stock-keeping unit (SKU) number or its equivalent. For example, an “Inspiron”™ laptop computer defined in object 312 may have one or more feature sets or combination of features. Thus, object 318 may represent a first SKU for an Inspiron with a 12 inch screen, a second SKU for an Inspiron with a 15 inch screen, etc.

Objects 314 and 316 represent respective multi-tiered pricing levels, analogous to the price book entries discussed above in connection with objects 212 and 214 of FIG. 2. For example, object 314 may represent a price schedule for the SKU identified in object 318 as defined by either a governmental, educational, or consumer pricing scheme, and object 316 may represent the unique price (price book entry) for the SKU within the particular scheme.

Object 320 represents a “bundle” of related products, also referred to as a product family, such as a desktop computer, a printer, and an internet camera (web cam). As an additional non-limiting example, object 320 may represent a “back to school” promotional campaign including a product bundle consisting of a backpack, lunch box, and school sweatshirt. In one embodiment, the various products in the bundle are offered by a single enterprise customer; alternatively, two or more enterprise customers can partner together and share catalog information in the commerce cloud and present a bundle to the purchaser on one or both company online stores. In either case, the products which make up the product family may be selected from one or more product categories (object 310) within a particular store (object 308).

With continued reference to FIG. 3, second module 304 includes an object 322 for configuring the currency associated with the store defined in object 308, such as U.S. dollars, Japanese Yen, British Pounds, and the like. An object 324 represents the store locale, such as an English speaking or French speaking region in Canada, and is used to further define the uniform resource locator (URL) (object 326) associated with the store (e.g., “.uk”, “.de”, “.biz”). An object 328 represents the high level language attribute of the online store which, in conjunction with locale object 324, defines the textual (written) language for use in each geographical region (object 330).

An object 338 allows products within the store (or stores) defined by object 308 to be bundled together. Similarly, a family group map function (object 340) facilitates the mapping of product family groups which defines local product family group strings (object 342) to be used in the online catalog.

A local strings object 332 represents the various high level strings used in the interactive online store, such as “Welcome to our online store, Susan”, “Today is September 2”, and the like. Local strings object 332 is used to generate local string codes (object 334) which, in conjunction with object 342 (local strings group), produces the local strings map (object 336) used to present the interactive product catalog to the consumer.

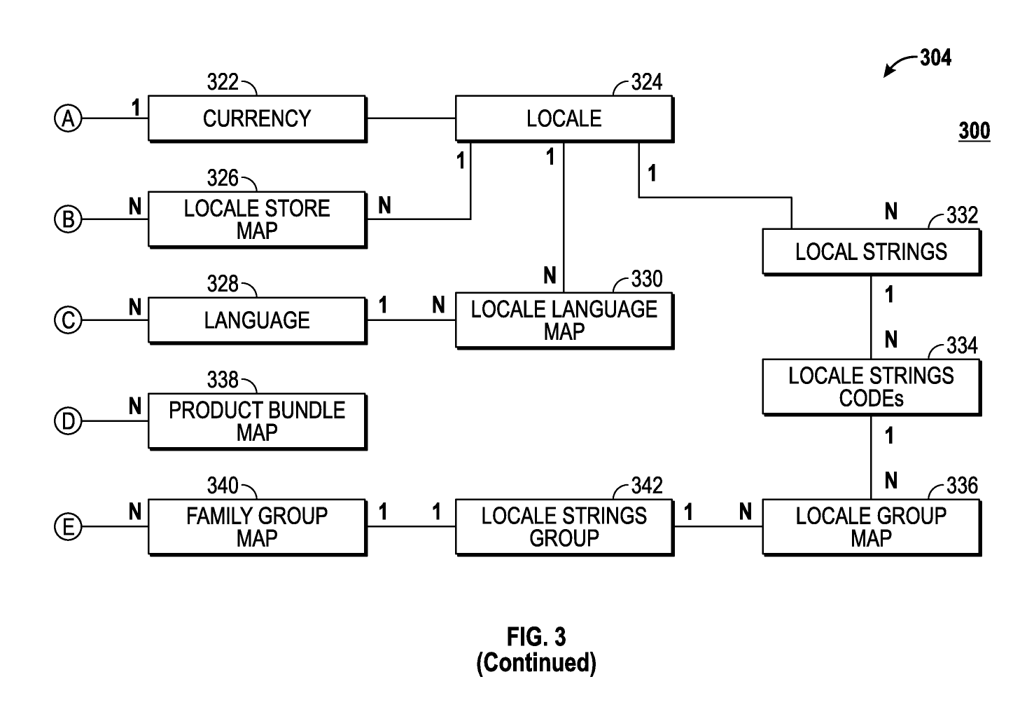

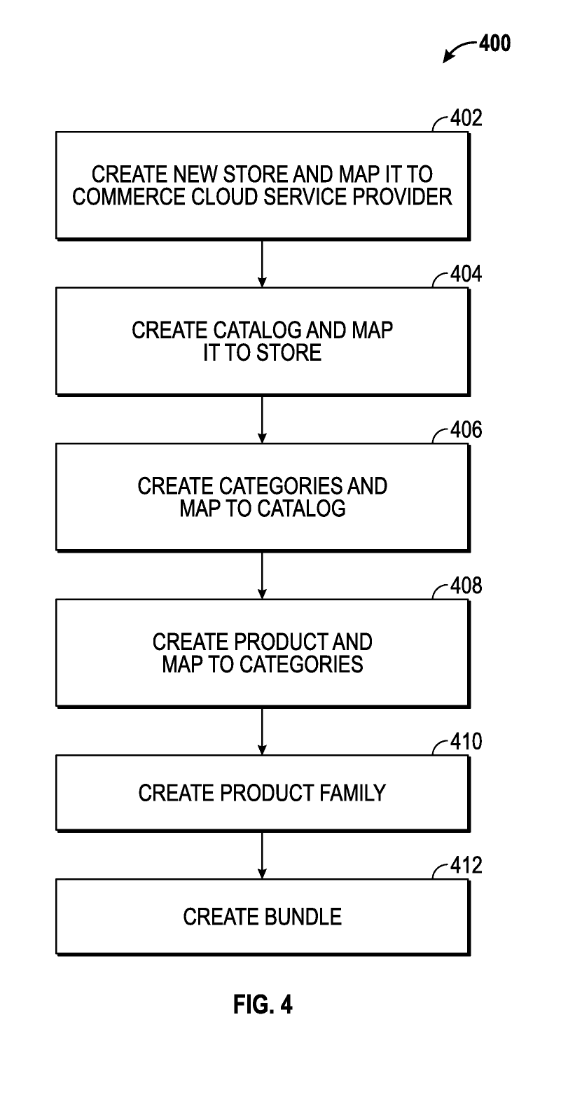

FIG. 4 is a flow chart illustrating a method 400 for creating a product catalog including creating the aforementioned expanded product metadata in accordance with an embodiment of the present disclosure. In particular, method 400 includes creating a new store and mapping it to the cloud service provider (task 402). A catalog is then created and mapped (task 404) to the store created in task 402. Catalog categories are then created and mapped (task 406) to the catalog previously created in task 404. A product is then created (task 408) and mapped to the categories created in task 406. A product family is then created (task 410), followed by the creation of a product bundle (task 412).

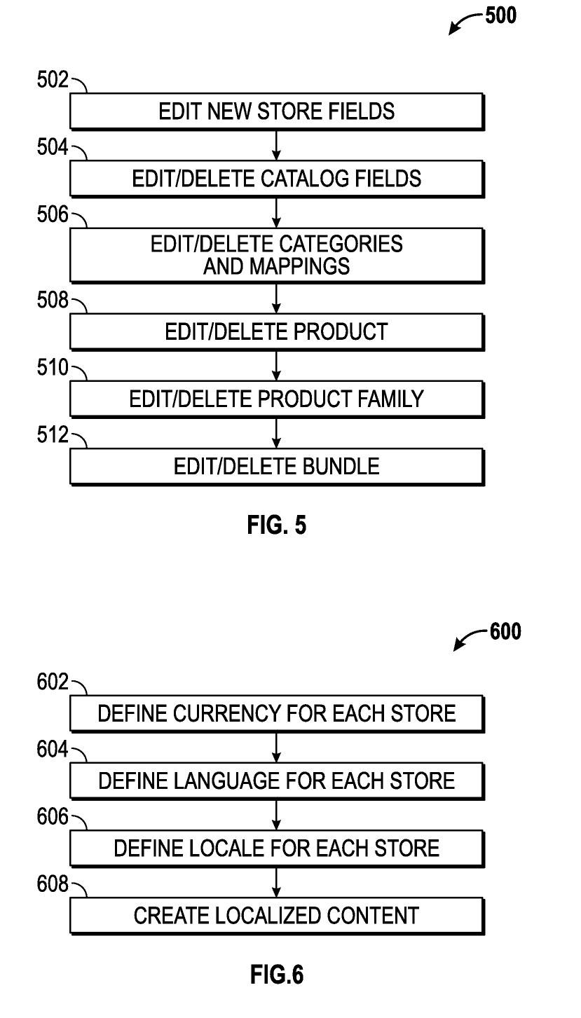

FIG. 5 is a flow chart illustrating a method 500 for editing and deleting product catalog fields in accordance with an embodiment of the present disclosure. In particular, method 500 includes editing new store fields (task 502), editing and/or deleting catalog fields (task 504), and editing and/or deleting categories and their associated mappings (task 506). The products may also be edited and/or deleted (task 508). Similarly, the product families (task 510) and product bundles (task 512) may also be edited and/or deleted.

FIG. 6 is a flow chart illustrating a method 600 for providing localization support for a product catalog in accordance with an embodiment of the present disclosure. In particular, method 600 includes defining the currency (task 602) for each store, such as U.S. dollars, Japanese Yen, British pounds, and the like. Method 600 further includes defining (task 604) the language for each store, such as English, Japanese, German, French, and so on.

Method 600 further allows the operator to define (task 606) the locale for each store, for example by configuring the associated web address with a suffix such as “.com”, “.uk”, “.de”, and the like. Finally, method 600 facilitates the creation (task 608) of localized content, such as described above in connection with module 304 of FIG. 3.

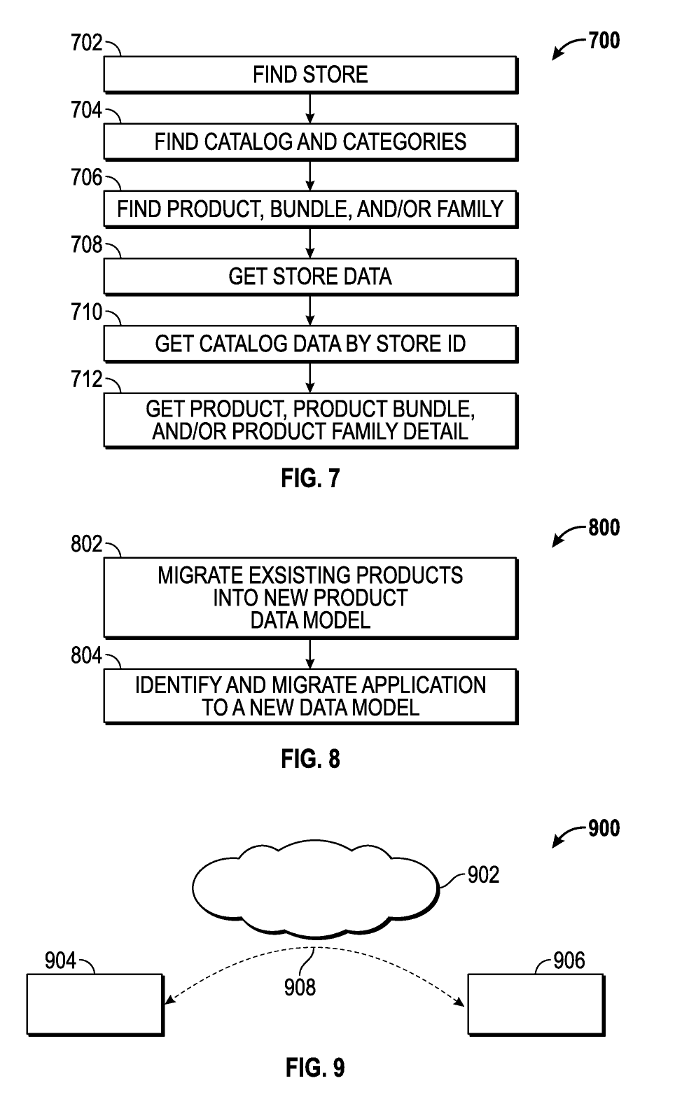

FIG. 7 is a flow chart illustrating a method 700 for navigating a product catalog (shopping) in accordance with an embodiment of the present disclosure. In particular, method 700 allows a consumer to find (task 702) a particular online store and locate or navigate to (task 704) that store's product catalog and product categories, for example, via an interactive web application hosted by the commerce cloud service provider.

Method 700 further permits the consumer (shopper) to find (task 706) bundled products and/or a product family, and to get (task 708) the store data for those products. Using the store data acquired in task 708, method 700 permits the shopper to obtain (task 710) the corresponding catalog data, including the product, product, family and/or product bundle detail (task 712).

FIG. 8 is a flow chart illustrating a method 800 for migrating an existing product catalog to the expanded data model described herein in accordance with an embodiment of the present disclosure. In particular, method 800 includes migrating (task 802) existing product data from a silo-type data model to the new data model of the type shown in FIG. 3. Method 800 further includes identifying and migrating (task 804) the product catalog application to the new data model described herein.

FIG. 9 is a schematic block diagram illustrating a conceptual layout of a partnering arrangement 900 involving two enterprise customers sharing product catalog information using a commerce cloud based catalog application in a multitenant environment. More particularly, a first enterprise customer 904 establishes an account relationship with a commerce cloud service provider 902 for an online product catalog using the expanded data model discussed herein. Similarly, a second enterprise customer 906 establishes a second account relationship with provider 902. When enterprise customers 904 and 906 desire to partner together and jointly market products (e.g., bundle), they may share their product data with each other using the catalog application hosted on the cloud, as indicated by the dotted line 908 connecting the two enterprise customers.

A method of creating an online product catalog is provided. The method includes hosting, by a commerce cloud service provider, a catalog application for use in a multitenant computing environment, establishing a contractual relationship between the service provider and an enterprise customer, and providing, pursuant to the relationship, the enterprise customer with administrative access to the application via the commerce cloud.

The method further includes creating a store using the administrative access; creating a product catalog and mapping it to the store; and creating at least one product category and mapping the product category to the product catalog. The method further involves creating at least one product entry using the application, and mapping thee product to the product category. The method may also involve creating a product family and mapping the product entry to the product family.

In one embodiment, the method includes creating a product bundle and mapping the product entry to the product bundle. In a further embodiment, the method involves assigning a price book category to each product entry, wherein the price book category may be a government, consumer, or an education based pricing schedule. The method may also include assigning a price book entry to each product entry, wherein the price book entry corresponds to a dollar value.

In a further embodiment, the method involves assigning a unique product identifier to each product entry, wherein the product identifier is a stock-keeping unit (SKU) number. The method may also include defining a currency, language, locale, and localized content for each store, wherein creating localized content involves defining local strings on a web page for presenting the online product catalog to consumers.

A method of navigating an interactive online product catalog is also provided. The method includes hosting, by a commerce cloud service provider, a catalog application for use in a multitenant computing environment; providing an enterprise customer with administrative access to the application via the commerce cloud; creating, by the enterprise customer, a store, a category, and at least one product entry using the administrative access; locating, by a consumer using the online product catalog, the store; and selecting, by the consumer, at least one product entry for purchase.

In one embodiment, the method also includes creating, by the enterprise customer, a product bundle and selecting, by the consumer, the product bundle for purchase or inspection.

A method of partnering between two entities to jointly promote complimentary products using a catalog service from a cloud-based service provider in a multi-tenant computing environment is also provided. The method includes establishing a first account between the service provider and a first enterprise customer to promote online sales of a first group of products using a first product catalog; establishing a second account between the service provider and a second enterprise customer to promote online sales of a second group of products using a second product catalog; and incorporating at least one of the second group of products into the first product catalog using the cloud based service.

In one embodiment, the method further includes creating, by the first enterprise customer, a first store, a first category, and a first product entry using the catalog service; creating, by the second enterprise customer, a second store, a second category, and a second product entry using the catalog service; and bundling the first and said second product entries together.

The method may also include presenting the bundled product entries to consumers in an online, interactive shopping application hosted by the cloud-based service provider using the multi-tenant computing environment.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method of creating an online product catalog, comprising:
hosting, by a commerce cloud service provider, a catalog application for use in a multitenant computing environment;
establishing a contractual relationship between said service provider and an enterprise customer;
providing, pursuant to said relationship, said enterprise customer with administrative access to said application via said commerce cloud;
creating a store using said administrative access;
creating a product catalog and mapping said product catalog to said store; and
creating at least one product category and mapping said at least one product category to said product catalog.

2. The method of claim 1, further comprising:
creating at least one product entry using said application; and
mapping said at least one product to said at least one product category.

3. The method of claim 2, further comprising;
creating a product family; and
mapping said at least one product entry to said product family.

4. The method of claim 2, further comprising:
creating a product bundle; and
mapping said at least one product entry to said product bundle.

5. The method of claim 2, further comprising assigning a price book category to said at least one product entry.

6. The method of claim 5, wherein said price book category comprises one of a government, consumer, and education pricing schedule.

7. The method of claim 5, further comprising assigning a price book entry to said at least one product entry.

8. The method of claim 7, wherein said price book entry comprises a dollar value.

9. The method of claim 2, further comprising assigning a unique product identifier to said at least one product entry.

10. The method of claim 9, wherein said product identifier comprises a stock-keeping unit (SKU) number.

11. The method of claim 2, further comprising defining a currency for said store.

12. The method of claim 2, further comprising defining a language for said store.

13. The method of claim 2, further comprising defining a locale for said store.

14. The method of claim 2, further comprising creating localized content for said store.

15. The method of claim 14, wherein creating localized content comprises defining local strings on a web page for presenting said online product catalog to consumers.

16. A method of navigating an interactive online product catalog, comprising:
hosting, by a commerce cloud service provider, a catalog application for use in a multitenant computing environment;
providing an enterprise customer with administrative access to said application via said commerce cloud;
creating, by said enterprise customer, a store, a category, and at least one product entry using said administrative access;
displaying, in response to a consumer initiated location request, said store using said online product catalog; and
offering, in response to a consumer initiated selection request, said at least one product entry for purchase.

17. The method of claim 16, further comprising;
creating, by said enterprise customer, a product bundle; and
selecting, by said consumer, said product bundle.

18. A method of partnering between two entities to jointly promote complimentary products using a catalog service from a cloud-based service provider in a multi-tenant computing environment, comprising:
establishing a first account between said service provider and a first enterprise customer to promote online sales of a first group of products using a first product catalog;
establishing a second account between said service provider and a second enterprise customer to promote online sales of a second group of products using a second product catalog; and
incorporating at least one of said second group of products into said first product catalog using said cloud based service.

19. The method of claim 18, further comprising:
creating, by said first enterprise customer, a first store, a first category, and a first product entry using said catalog service;
creating, by said second enterprise customer, a second store, a second category, and a second product entry using said catalog service; and
bundling said first and said second product entries.

20. The method of claim 19, further comprising presenting said bundled product entries to consumers in an online, interactive shopping application hosted by said cloud-based service provider using said multi-tenant computing environment.
